(19) United States
(12) Patent Application Publication
(10) Pub. No.: US 2004/0216083 A1
(43) Pub. Date: Oct. 28, 2004

(54) Programming tool and a method for creating programs

(75) Inventors: Georg Biehler, Nuernberg (DE); Matthias Diezel, Laufamholz (DE); Christine Gimpl-Wiegers, Postbauer-Heng (DE); Werner Hoefler, Eckental (DE); Ronald Lange, Fuerth (DE); Pablo Munoz Ibarra, Erlangen (DE); Hans-Peter Otto, Erlangen (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/724,254

(22) Filed: Dec. 1, 2003

Related U.S. Application Data
(63) Continuation of application No. PCT/DE02/01960, filed on May 28, 2002.

(30) Foreign Application Priority Data
Jun. 1, 2001 (DE) 10126863.7

(51) Int. Cl. G06F 9/44; G05B 15/00

(52) U.S. Cl. 717/102; 717/105; 700/1

(57) ABSTRACT

For complex automation tasks, it is generally known to program programmable control units using graphics languages. However, a problem in this regard is that such graphics languages show either only the sequence of operations over time or only the interaction of the objects (1-3). A novel language, particularly involving the use of a sequence chart diagram, is proposed to display and program the object interaction and its sequence over time in a single common representation. To this end, an additional control element (4) is provided for controlling the addressing and the sequence of the object interactions over time.

This is a Continuation of International Application PCT/DE02/01960, with an international filing date of May 28, 2002, which was published under PCT Article 21(2) in German, and the disclosure of which is incorporated into this application by reference in its entirety.

### FIELD OF AND BACKGROUND OF THE INVENTION

The present invention relates to a method and a programming tool for generating programs, particularly programs in automation technology, to implement at least one or more, particularly distributed, stored program controllers (“SPC's”), such as are used for open and/or closed loop control of automation tasks in technical processes.

To solve simple or complex automation tasks, stored program controllers are used in which a process is mapped and controlled in an open and/or closed loop manner using a predefined program flow of the process. For this purpose, the automation task to be solved is divided into objects or function blocks. These objects or function blocks do not necessarily have to correspond to the components of the technical process. However, this can be a useful approach to find a programming solution for the automation task. The program modules, like the real components involved, must interact via interfaces. As in the case of real components, the manufacturer of program modules needs to focus on a general solution to the problem rather than on the specific application case. The interfaces of such program modules are therefore always designed for the general case rather than the corresponding application. In other words, just like the components of a subassembly, that do not initially “know” the other elements of the subassembly, the program modules generally do not “know” the other program modules involved. Thus, as a rule, the program modules must generally be adapted to the corresponding application.

Moreover, for more complex solutions, textual programming languages are inefficient. For this reason, graphics languages, such as ladder diagrams (“LD”) or function block diagrams (“FBD”) have been successfully used in automation technology for many years. These are graphic representations of, for example, complex processes and such graphic representations are known generally from electrical engineering. Especially well established are the generally known block diagrams and flow diagrams, as well as the circuit diagrams known generally from control engineering. Nearly all technical processes can be represented by such diagrams as well as implemented by means of graphics languages.

As a rule, the components, i.e. the objects of the programs, are in turn associated with individual program modules that are interlinked by corresponding instructions. A compiler is typically used to ensure the semantically correct coordination of the program run which is generated using a graphics language.

All of the above representations have in common the problem that they visualize either only the sequence of the program over time, or only the objects involved and/or their actions. As a result, it is usually difficult to reconstruct, let alone monitor, the solution of the closed loop control or automation task by studying the program syntax. In particular, this is possible only after time-consuming crosschecks. This can make real time monitoring and especially troubleshooting difficult.

### OBJECTS OF THE INVENTION

Thus, an object of the present invention is to provide a novel language that is easier to use. Another related object is to provide a novel language that improves clarity for creating programs, especially programs in automation technology, and thereby offers other advantages in the monitoring of running processes.

### SUMMARY OF THE INVENTION

Consistent with one formulation of the present invention, a programming tool is specified for at least one of creating and displaying programs to control the flow of a process using a graphics language for the simultaneous representation in a diagram, on a display device, of a sequence over time and interactions of objects that are involved in the control of the process, wherein a coordination element is provided, which manages the sequence over time and the interactions of the objects involved.

An idea underlying a programming tool consistent with the formulation of the present invention, as set forth above, is to provide an additional coordination element that manages the sequence of operations over time and the object interactions. As a result, the objects and their interactions can be advantageously interlinked in a graphics language, without their precise coordination being relevant at the time of programming. This additional coordination element makes it possible to use a novel graphics language that enables the visualization, on a display device, in a common diagram, of both the sequence of operations over time and the interaction of the objects that are involved in the corresponding technical process. Although the additional coordination element is provided in the form of hardware and/or software, it does not appear in the graphics language. Indeed, the visualization of the additional coordination element is neither required nor meaningful since an object of the present invention is to improve the clarity of the representation. The formulation of the invention, as set forth above, offers significant advantages during programming, as well as during the monitoring of technical processes required particularly in connection with stored program controllers.

The coordination element can be implemented, for example, as a virtual or an additional real processor in connection with the one or more stored program controllers. If it is implemented as a virtual processor, the coordination element is a corresponding software module.

The coordination element receives essentially all the object calls and determines the instant and/or the addressee for the forwarding of the calls to the respective object involved.

To make the novel graphics language as universally applicable as possible, a graphic representation for all the objects of a technical process is provided. A graphic representation is also provided for all the object interactions required to solve the automation task. For the purpose of implementation, these objects and object interactions can be called and interconnected by an editor.

Further, the arrangement of the objects and object interactions using an editor can be an interconnection of program modules, which are preferably, but not necessarily, implemented in machine language.

In another illustrative and non-limiting embodiment, further advantageous object interactions, such as branching of the object calls, parallel connection of object calls, synchronization of object calls, or recursions of object calls are implemented within the scope of the graphics languages consistent with the present invention.

A novel graphics language is particularly advantageous in conjunction with a display device that visualizes the program in such a way that the object interactions or the objects are represented on an x-axis, and the sequence of the object interactions over time is represented on a y-axis, preferably, but not necessarily, from top to bottom. The representation of a program flow as a function of time from top to bottom also corresponds to the current practice of monitoring.

The compact programming and visualization of technical processes and their programming by way of the novel graphics language described above can advantageously be used for monitoring purposes. To this end, the language can be constructed and represented in real time.

In the event that the automation task is so complex, or runs so quickly that the user can no longer comprehend it, another formulation of the present invention provides that the display device has a buffer memory that enables a buffered representation of the process. This buffer memory can also be used for troubleshooting or in connection with a process halt.

Further, for a combined representation of the objects, their interactions and the sequence of these interactions over time, it has proven to be advantageous to use a sequence chart diagram for the presentation.

Consistent with another formulation of the present invention, a method for programming and representing a program run for at least one of an open-loop and a closed-loop control of a process, using at least one programmable controller, in which a graphics language is used to implement a process capable of being represented by objects and their interactions is specified, the method comprising:

calling a plurality of objects involved in the process in a common diagram;

calling a plurality of the respectively required object interactions in the common diagram;

editing the selected objects and object interactions, as well as the sequence of the object interactions over time, in the common diagram; and

translating the previously implemented program into at least one of a corresponding high-level language and a corresponding machine language.

The above-mentioned method uses the advantages afforded by the novel graphics language for creating programs. Further, the method advantageously uses a presentation in which the objects and their interactions are displayed on an x-axis, and their sequence over time on a y-axis, such that they are combined in a common presentation.

Consistent with another formulation of the present invention, a programming tool for creating and providing a graphic representation in a diagram of programs that control the flow of a process is specified, comprising:

a coordination element that manages interactions of objects that are involved in the control of the process and manages a sequence of the object interactions over time; and

a display device that provides a graphic representation of the object interactions and a graphic representation of the sequence of the object interactions over time, simultaneously in the diagram.

### BRIEF DESCRIPTION OF THE DRAWINGS

The present invention will now be described in greater detail, by way of example, with reference to illustrative and non-limiting embodiments schematically depicted in the accompanying drawings in which:

FIG. 1 is a block diagram showing the objects of a technical process;

FIG. 2 is a block diagram of the interaction of the objects depicted in FIG. 1;

FIG. 3 shows a program-based connection of the objects in a sequence chart display consistent with the present invention; and

FIG. 4 is a general representation in sequence chart form with additional object interactions.

### DETAILED DESCRIPTION OF THE PREFERRED EMBODIMENTS

The present invention will now be described in detail by describing illustrative and non-limiting embodiments thereof with reference to the accompanying drawings. In the drawings, the same reference characters denote the same elements.

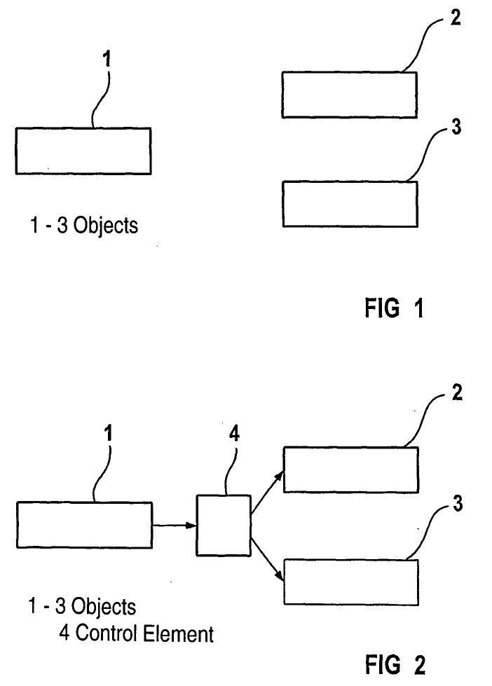

FIG. 1 is a block diagram of a simple automation task to be solved by programming a programmable controller (not depicted in FIG. 1). In the example outlined in FIG. 1, a machine 1 supplies a first conveyor belt 2 and a second conveyor belt 3. In technological respects, a frequent problem is that the machine and the conveyer belts are made by different manufacturers. Accordingly, one cannot simply assume that the interfaces of the elements involved in the technical process are coordinated. However, the manufacturer involved has an interest in its equipment being usable as universally as possible.

This problem is also reflected in the programming solution of the automation task at issue in FIG. 1. In the simplest embodiment, both the machine 1 and the first and second conveyor belts 2 and 3, respectively, can be connected as objects of a language. The language is a user-specific programming language for solving the automation task. Using the language, the objects involved are interconnected by corresponding functions or object interactions and are placed in a meaningful sequence as a function of time. This means that, in terms of the program, each output of the machine 1 must be supplied to the conveyor belts 2 and 3.

In other words, a product of the machine 1 must be supplied to either the first conveyor belt 2 or the second conveyor belt 3, which must transport it away at a defined instant. Thus, the machine must inform the conveyor belts 2 and 3 of the completion of the product that is to be transported away, and one of the two conveyor belts must be activated to pick up the product.

In the simplest embodiment, this is reflected by a corresponding activation of the objects by a program. It is more realistic, however, to assume that, in terms of the program, a complex machine or a conveyor belt is represented by a plurality of objects. Such complex processes, of course, can become very intricate very quickly, which can be reflected in a corresponding intricacy of the program. It has been found, in particular, that purely textual programming languages are not suitable to create such complex programs. Therefore, in automation technology, graphics languages such as ladder diagrams (“LD”) or function block diagrams (“FBD”) have become generally accepted.

In such graphics languages, a complex technical process is reflected, for example, in block diagrams, which are often used in control engineering. Block diagrams are advantageous in that complex processes can be represented in a single coherent image. A problem with such block diagrams is that they provide no information on the actual flow of the process over time. This problem is solved by means of a representation in so-called flow diagrams, in which the individual actions are shown in order, from top to bottom. Typically, these flow diagrams show only the actions, but not the objects of the process, so that the flow diagrams contain no information at all about the interaction of the objects.

The present invention is based on the finding that an actual or virtual higher-level control element 4 must be provided to implement a simultaneous representation of the objects, the interaction of the objects, and the sequence of this interaction over time. This control element 4 organizes the addressing of the objects among each other and the sequence thereof over time. This means that essentially all the messages and calls of an object are first transmitted to the control element 4, because the control element 4 uses the call via other parameters to detect which object should be addressed and called, or actuated, based on this call. Furthermore, the control element 4 is implemented in such a way that it also organizes the sequence of the object interactions over time. In the present example, the control element 4 can be a multiplexer. In connection with one or more stored program controller(s), the control element 4 can be implemented by an additional processor or by a corresponding software module. However, the control element 4 as such is not displayed in FIG. 1.

The resulting interconnection of the objects 1, 2, and 3 is depicted in FIG. 2.

According to FIG. 2, the machine 1 transmits all completion signals to a control element 4, which uses parameter queries, such as the measurement result of a balance, to decide whether either the first conveyor belt 2 or the second conveyor belt 3 should be actuated. The control element 4 further receives any process signals of the conveyor belts 2 and 3, such that the control element 4 can also “decide” whether it is even possible to actuate the conveyor belt 2 or 3 at a given instant. However, this is only one possible criterion that can lead to a time-based organization of the sequence. The representation according to FIG. 2 merely serves for clarification.

FIG. 2 is a conventional block diagram that contains no information with respect to time. It is therefore not suitable for any programming or monitoring consistent with the present invention.

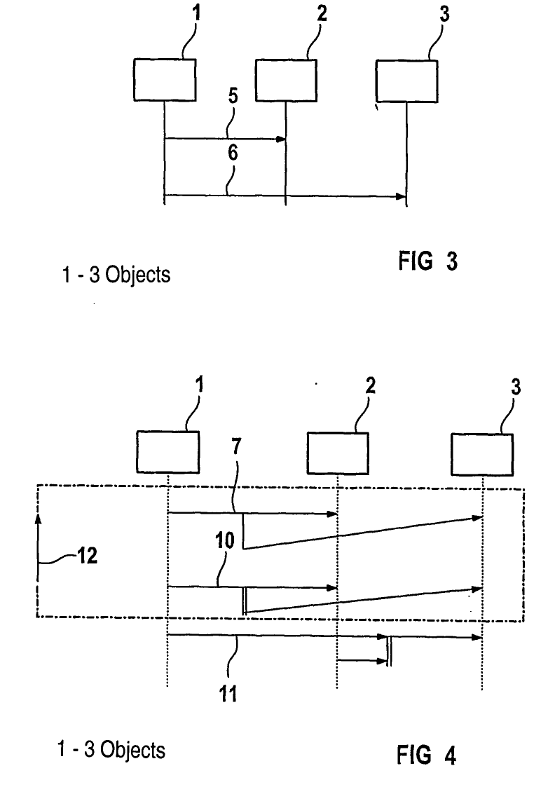

For this purpose, the solution depicted in FIG. 3 is used, in which the automation task and the objects involved are represented in a sequence chart diagram. In the most basic configuration, the representation first shows the objects involved 1, 2, and 3, in a clear arrangement. Further, the representation shows two possible object interactions, namely, the delivery of an output of the machine 1 to the conveyor belt 2, and a further delivery of an output of the machine 1 to the conveyor belt 3. A first arrow 5 indicates the delivery of an output of the machine 1 to the conveyor belt 2, and a second arrow 6 indicates the delivery of an output of the machine 1 to the second conveyor belt 3. It is clear from the arrangement of the first arrow 5, above the second arrow 6, that the delivery to the first conveyor belt 2 precedes the delivery to the second conveyor belt 3. A corresponding dimensioning of an ordinate (not depicted in FIG. 3) even makes it possible to read from the diagram the precise time interval between the first object interaction 5 and the second object interaction 6.

The control element 4 (not depicted in FIG. 3) assumes the task of addressing the calls or object interactions 5 and 6 and their sequence over time.

In terms of programming, the representation of FIG. 3 should be understood to mean that the objects 1, 2, and 3 are each implemented as program modules such that these objects are offered for interconnection in a single representation. However, the user does not need to be concerned about the specific interconnection of the interfaces between the objects 1, 2, and 3. This specific interconnection is done either by the control element 4 (not depicted in FIG. 3), or is supplied with an initial parameterization of the one or more programmable control device(s) as delivered by the manufacturer.

The objects 1, 2, and 3 can then be interconnected as desired using the graphics language illustrated in FIG. 3. The interconnection of the objects 1, 2, and 3 by object interactions 5 or 6 is ultimately a programming of the automation task. For this purpose, the user is offered both the object interactions 5 and 6 provided by the graphics language, and the objects 1, 2, and 3, to be interconnected or involved in the technical process. This may be accomplished, for example, with a corresponding contextual menu.

The graphics language depicted in FIG. 3 offers a number of other valuable object interactions for interconnecting the objects 1, 2, or 3. One possible selection of these object interactions is illustrated in FIG. 4. It should be noted, of course, that the representations of the objects and object interactions selected here are only one of many possible object representations, and the selection of the different options shown should not be understood as being conclusive. In an alternative illustrative and non-limiting embodiment, it is also possible to use other symbols, colors, or 3-D effects. According to the representation of FIG. 4, the objects 1, 2, or 3 can be interconnected as follows:

First, the object interaction 7 represents a program branch. The call of the object 1 is addressed to the object 2 or to the object 3 as a function of checking the condition a>b. The checking of the condition is done by the control element 4 (not depicted in FIG. 4). Such a branch, of course, can also be created unconditionally.

In automation technology, parallel processes must also be controlled. One possible programming of such parallel processes can take place in accordance with the object interaction 10. Here, the call of the object 1 is transmitted by the parallel connection 10 to both the object 2 and the object 3. In the present case, the transmission is simultaneous, which is reflected in a corresponding appropriate representation on the time axis extending from top to bottom.

A further valuable interaction symbol is the synchronization connection 11. This interaction symbol means that the object 3 is called only if both the object 1 and the object 2 are called. Accordingly, only if there are two simultaneous, still unprocessed calls of the objects 1 and 2, is a call addressed to the object 3.

Finally, FIG. 4 shows the useful object interaction of a loop or a jump 12. Specifically, the object interactions arranged within the dash-dotted lines are repeated until a loop counter has reached a predefined value or until a defined condition is met. The loop counter and/or the meeting of the condition are monitored by the control element 4 (not depicted in FIG. 4).

As described above, a programming tool is provided as well as a method for programming, particularly for programmable control devices such as those used in automation technology. A novel graphics language makes it possible to combine, arrange, and program objects and their interactions in a common representation. This significantly facilitates the programming of automation tasks, particularly complex automation tasks, and their monitoring.

The above description of illustrative and non-limiting embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A programming tool for at least one of creating and displaying programs to control a flow of a process using a graphics language for simultaneous representation in a diagram, on a display device, of a sequence over time and interactions of objects that are involved in the control of the process, wherein a coordination element is provided, which manages the sequence over time and the interactions of the objects involved.

2. A programming tool as claimed in claim 1, wherein the process is an automation technology process.

3. A programming tool as claimed in claim 1, wherein the process is a technical process.

4. A programming tool as claimed in claim 1, wherein the program is executed in plural, distributed stored program controllers.

5. A programming tool as claimed in claim 1, wherein a virtual or additional real processor is provided as the coordination element.

6. A programming tool as claimed in claim 4, wherein a virtual processor or an additional real processor is provided as the coordination element in connection with the distributed stored program controllers.

7. A programming tool as claimed in claim 1, wherein at least substantially all calls of the objects are processed by the coordination element.

8. A programming tool as claimed in claim 7, wherein the coordination element determines at least one of the instant of each call and the addressee of each call.

9. A programming tool as claimed in claim 1, wherein the graphics language comprises a graphic representation of all of the objects and a graphic representation of all of the object interactions, wherein each graphic representation, of the objects and the object interactions, respectively, is called and interconnected using an editor to implement an executable program.

10. A programming tool as claimed in claim 9, wherein each graphic representation in the diagram of an object and an object interaction is associated with an instruction or a program module.

11. A programming tool as claimed in claim 10, wherein the instruction or the program module is in machine language.

12. A programming tool as claimed in claim 9, wherein the following additional object interactions:
branching of an object call;
parallel connection of an object call;
synchronized connection of at least two interactions; or
loop or jump to repeat at least one of an instruction and a program segment;
are each represented conditionally or unconditionally in the diagram and are thereby implemented correspondingly.

13. A programming tool as claimed in claim 1, wherein a representation of the graphics language in the diagram shows the object interactions a first axis, and shows a sequence of the object interactions over time on a second axis of the diagram.

14. A programming tool as claimed in claim 13, wherein the representation of the graphics language in the diagram is real-time capable.

15. A programming tool as claimed in claim 14, wherein the display device is associated with a buffer memory for buffered representation of the flow of the process using the graphics language.

16. A programming tool as claimed in claim 13, wherein a sequence chart representation is selected as the diagram.

17. A programming tool as claimed in claim 13, wherein the diagram shows the sequence of object interactions over time on the second axis of the diagram from top to bottom.

18. A programming tool as claimed in claim 13, wherein the graphics language in the diagram can be constructed in real time.

19. A method for programming and representing a program run for at least one of open-loop and closed-loop control of a process, using at least one programmable controller, in which a graphics language is used to implement a process capable of being represented by objects and object interactions, comprising:
calling a plurality of objects involved in the process in a common diagram;
calling a plurality of respectively required object interactions in the common diagram;
editing the selected objects and object interactions, as well as the sequence of the object interactions over time, in the common diagram; and
translating the previously implemented program into at least one of a corresponding high-level language and a corresponding machine language.

20. A method as claimed in claim 19, wherein the objects and the object interactions are arranged on a first axis of the common diagram, and wherein the successive sequence of the object interactions over time is represented by arranging the object interactions on a second axis of the common diagram.

21. A method for programming as claimed in claim 19, wherein the process is an automation technology process.

22. A method for programming as claimed in claim 19, wherein the process is a technical process.

23. A method for programming as claimed in claim 20, wherein at least one of the arrangement of the objects and the object interactions, and the representation of the successive sequence of the object interactions over time, in the common diagram are real-time capable.

24. A method for programming as claimed in claim 20, wherein a sequence chart representation is selected as the common diagram.

25. A method for programming as claimed in claim 20, wherein the common diagram is two-dimensional.

26. A method for programming as claimed in claim 20, wherein the successive sequence of the object interactions over time is represented by arranging the object interactions from top to bottom on the second axis of the common diagram.

27. A programming tool for creating and providing a graphic representation in a diagram of programs that control the flow of a process, comprising:
a coordination element that manages interactions of objects that are involved in the control of the process and manages a sequence of the object interactions over time; and
a display device that provides a graphic representation of the object interactions together with a graphic representation of the sequence of the object interactions over time in the diagram.

28. A programming tool as claimed in claim 27, wherein the process is an automation technology process.

29. A programming tool as claimed in claim 27, wherein the process is a technical process.

30. A programming tool as claimed in claim 27, further comprising plural distributed stored program controllers in which the program is executed.

31. A programming tool as claimed in claim 27, wherein the coordination element comprises a virtual processor or an additional real processor.

32. A programming tool as claimed in claim 30, wherein the coordination element comprises a virtual processor or an additional real processor in connection with the plural distributed stored program controllers.

33. A programming tool as claimed in claim 27, wherein at least substantially all calls of the objects are processed by the coordination element.

34. A programming tool as claimed in 33, wherein the coordination element determines at least one of the instant of each call and the addressee of each call.

35. A programming tool as claimed in claim 27, further comprising an editor that calls and interconnects the graphic representation of the objects and the graphic representation of the object interactions, respectively, to implement an executable program.

36. A programming tool as claimed in claim 35, wherein each graphic representation in the diagram of an object and an object interaction is associated with an instruction or a program module.

37. A programming tool as claimed in claim 36, wherein the instruction or the program module is in machine language.

38. A programming tool as claimed in claim 35, wherein the following additional object interactions:
branching of an object call;
parallel connection of an object call;
synchronized connection of at least two interactions; or
loop or jump to repeat an instruction and/or a program segment;
are each represented conditionally or unconditionally in the diagram and are thereby implemented correspondingly.

39. A programming tool as claimed in claim 27, wherein the graphic representation in the diagram shows the object interactions on a first axis, and shows a sequence of the object interactions over time on a second axis of the diagram.

40. A programming tool as claimed in claim 39, wherein the diagram shows the sequence of object interactions over time on the second axis of the diagram from top to bottom.

41. A programming tool as claimed in claim 39, wherein the graphic representation is depicted in real-time.

42. A programming tool as claimed in claim 39, wherein the graphic representation is constructed in real-time.

43. A programming tool as claimed in claim 41, wherein the display device is associated with a buffer memory for buffered representation of the graphic representation.

44. A programming tool as claimed in claim 39, wherein a sequence chart representation is selected as the diagram.
